(19) United States
(12) Patent Application Publication
(10) Pub. No.: US 2009/0293052 A1
(43) Pub. Date: Nov. 26, 2009

(54) APPARATUS AND METHOD FOR PORT ADAPTOR FOR PERIPHERAL DEVICE SOFTWARE AND DATA

(76) Inventor: Seung Pil Kim, Mountain View, CA (US)

Correspondence Address: Seung Pil Kim, 413 Kent Dr, Mountain View, CA, 94043, US

(21) Appl. No.: 12/126,885

(22) Filed: May 25, 2008

(51) Int. Cl. G06F 9/445; G06F 3/00

(52) U.S. Cl. 717/174; 710/2

(57) ABSTRACT

An adaptor for a peripheral device port includes non-volatile memory attached to the port using a port splitter or hub. The non-volatile memory is typically used for storage of peripheral device specific information such as device drivers and users' guide. Said adaptor provides necessary software as well as reference documents without any additional connection. A host computer sees an additional storage device in addition to a target peripheral device. This eliminates the need for CD or DVD devices for software installations or reference documents. Said adaptor can be easily integrated into a target device or cable for simpler usage.

Furthermore, the required software such as device driver can be automatically installed using an auto-run program. This gives a greater convenience to the users since the peripheral device virtually ready for use out of the box without manual software installation.

### BACKGROUND

1. The Field of the Invention

This invention relates to interfaces between computers and peripheral devices generally and, more particularly, to novel apparatus and methods for improving software installation and data access specific to a peripheral device.

2. The Background Art

This invention relates to devices and methods for improving device driver and/or application software installation process and storing device specific information. Of particular interests are USB interface devices because of the popularity of USB connections among peripheral devices such as printers, cameras etc. Electronic devices with a certain type of PC interface usually comes with CD or DVD, called install CD/DVD, for software installations as well as reference documents such as User's Guide. One needs to install driver and/or application software in order to make the device function properly with a host PC. For each additional computer, installations should be done repeatedly before the device can be used.

In many situations, the install CD/DVD often get lost. One would resort to internet search to down load the necessary software. The process is not only time consuming but error prone due to multiple options one would have—one should find correct one amongst multiple device model numbers and multiple operating systems. Even worse, the older device model could be no more supported by the manufacturer and no software is available for download at all.

Even if the install CD/DVD is not lost, the driver software often need be updated to fix the bugs in the prior releases of the software distributed with the install CD/DVD. In the prior art, the software upgrade need be performed for all the PC's one by one and the installed software versions should match in order for the device perform uniformly across all the computers. This is a time consuming, labor intensive and error prone process.

In fact, a device specific software maintenance from installation to version upgrades is a serious task with staff members in business environment. In home computing environment, it has been an unavoidable chore before using new peripherals or electronic gadgets. Such an unpleasant step has been a great barrier to many general public in gaining access to new technologies from personal productivity tools to entertainment devices. This invention is targeted to help reduce such technical hurdles by removing CD/DVD based software installations and further automating a software set up process.

### BRIEF SUMMARY AND OBJECTS OF THE INVENTION

In view of the foregoing, it is an objective of the present invention to provide an improved apparatus and method for software installations, upgrade of device drivers and application software for peripheral devices in single or multiple host computer environments.

It is a further objective of the invention to provide a device and method for easy access to reference documents such as user manual and data book for the target peripheral device without mounting CD/DVD as well as without copying of CD/DVD contents into host computers.

In accordance with the present invention, the foregoing objects are met by the provision of a device for port adaptor that has an imbedded data storage. The imbedded data storage shares an interface with the target device. The target device is connected to the host computer according to the original standard interface specification by utilizing port splitter or also known as a port hub. As is well known to those skilled in the art, one can implement a hub using commercially available semiconductor chips for well known interface standard specifications such as USB.

According to certain aspects of the invention, peripheral device specific software and reference data are stored in non-volatile memory within the port adaptor.

According to another aspects of the invention, the device can be made easily attachable to target USB devices. Each target device has its own adaptor attached to it and the attached adaptor provides the identical connectivity to the host computer. Depending on situations, the device can be attached to the cable rather than the target device.

According to further aspects of the invention, the said adaptor does not require power source since USB port from the PC can supply power source for the flash memory system.

According to certain aspect of the invention, software installation is initiated automatically when the target peripheral device is connected to a host computer for the first time. As is well known to those skilled in the art, one can initiate execution of a particular program upon detection of a new device connected to a USB port. Therefore, no manual software installation using install CD/DVD is necessary.

According to certain aspect of the invention, one needs to manually upgrade the software only in the said adaptor. In the prior art, one had to manually update the software for all the computers having the previous versions of software.

According to certain aspect of the invention, software updates for a host computer is automatically initiated when the peripheral device is connected. The automatic upgrade is triggered by detecting the installed software version and when the installed version is older than the one currently available in the adaptor. Therefore, no manual software upgrade is necessary for host computers.

### BRIEF DESCRIPTION OF THE DRAWINGS

It is not intended that the invention be summarized here in its entirety. Rather, further features, aspects and advantages of the invention will be set forth in or apparent from the following description and drawings. In the drawings:

FIG. 1 is an illustration of current invention where necessary software or data are available for installation from the pass-through USB port adaptor (cross hatched) through a shared USB port on a host computer.

FIG. 2 illustrates prior art where host PC-1 and host PC-2 are both need be installed with necessary software prior to use of a peripheral device. The installations are done manually one by one with the identical install CD/DVD.

FIG. 3 in an illustration of an embodiment of an adaptor in current invention where port splitter or port hub provides two downstream ports from one downstream port. One of the port is connected to a non-volatile memory system, such as USB flash memory system, and the other is left for connection to the original target device.

FIG. 4 is an illustration where the adaptor is an integral part of the peripheral device.

FIG. 5 is an illustration of the program install flow. A user needs to select the default location of the installation software in the flash memory file system. Since the location and the name of the folder is predetermined stays unchanged, it is straightforward to select the right one.

FIG. 6 is an automated version of software installation process where an auto-run script program supplies the necessary predetermined information for installation. The installation process performed without a user being involved.

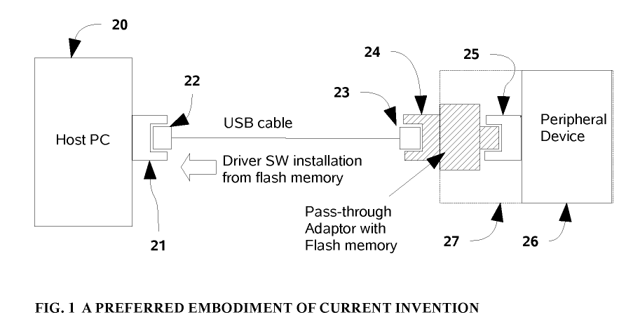

### DETAILED DESCRIPTION OF PREFERRED EMBODIMENT

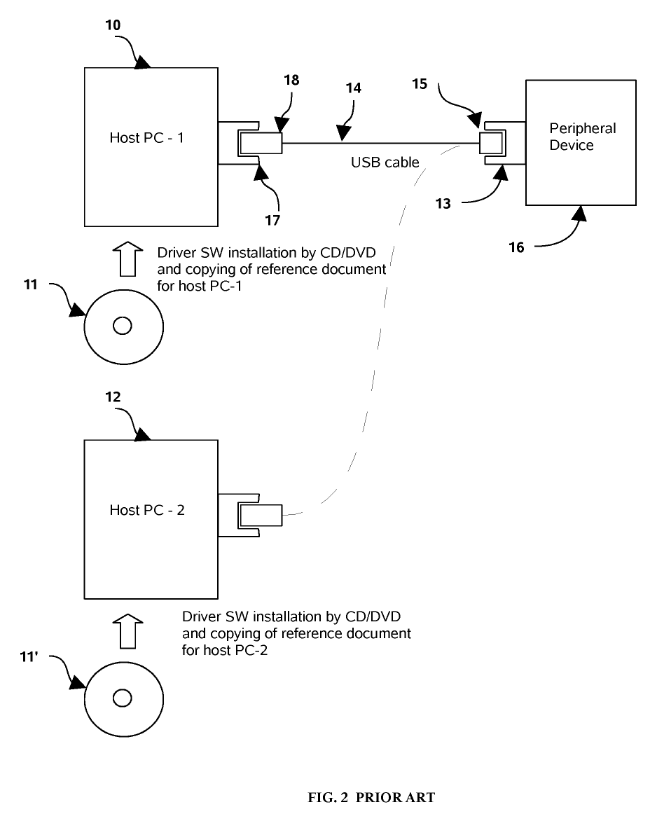

When a USB device, for example, a USB printer 16 in FIG. 2, is to be used for the first time with a host PC-1 10, one would need to install a printer driver software and possibly an application software. This is typically achieved using a CD/DVD data storage device 11 and 11′ usually an identical device, called install CD/DVD, that came with the product. During the lifetime of a USB printer, however, one would have multiple PC's, for example, 10 and 12 in FIG. 2 that need be connected to the USB printer 16. In order for the device 16 to perform properly, each host computer 10 and 12 needs to have a proper software installed specifically matched to the printer as well as to each of the operating systems used on 10 and 12, respectively. As the number of computers increases, it becomes a significant undertaking to maintain proper software for all the host computers.

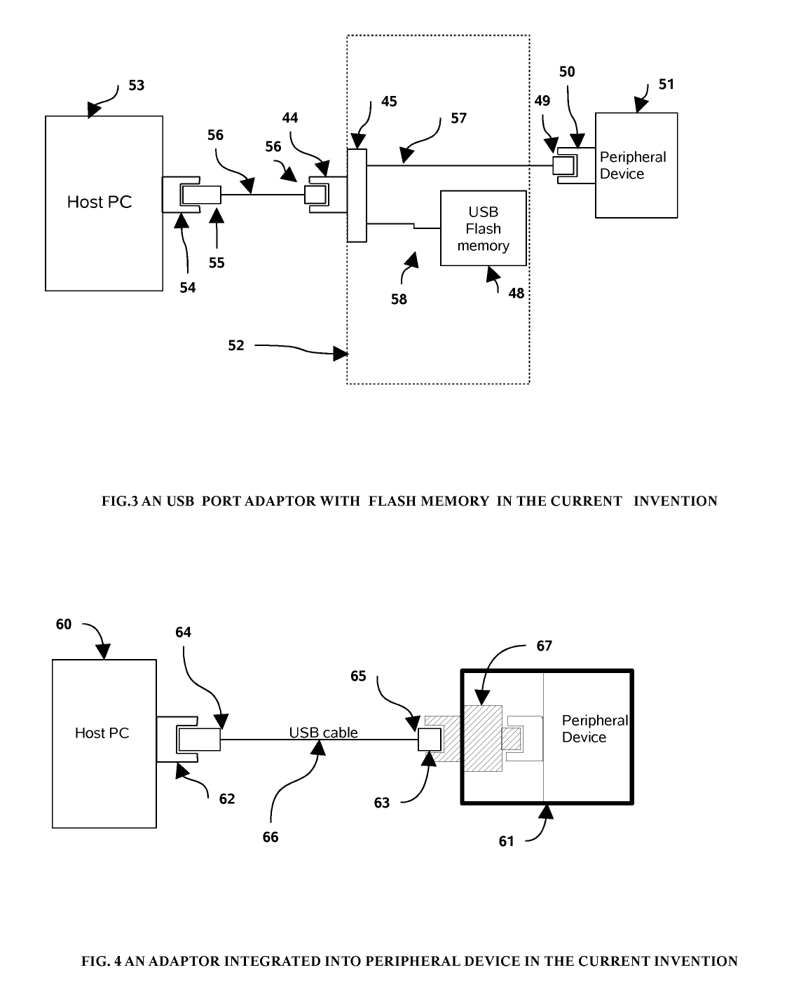

In a preferred embodiment of the invention, a USB port 13 on the target device 16 in FIG. 2 of prior art (typically, downstream Type-B female connector) is split into two ports as shown in FIG. 3. Device 44 in FIG. 3 is an identical device 13 in FIG. 2 where both being downstream Type-B female connector. The port 44 is split into two ports by a device 45, called port splitter or hub within a device 52. This particular hub is called one-to-two hub since one port is split into two ports. One of the resulting ports represented by the wire 57 is connected with the connector 49 (a USB Type-B male connector), while the other port represented by the wire 58 is directly connected to the USB flash memory system 48. The host computer sees both USB flash memory system 48 and the target device 51, as is the objective of the port hub device.

The current invention, represented by 52 in FIG. 3 can be first understood as a pass-through adaptor to a peripheral device with an imbedded non-volatile memory system. The pass-through adaptor can be implemented as a stand-alone standard port adaptor device or integrated into the target peripheral device 51 or integrated into a USB cable with one end being 55 and the other end being 49. For example, FIG. 4 shows an embodiment of the current invention where cross-hatched block 67 represents an integrated pass-through device integrated into a peripheral 61. Since the device 67 is inside a peripheral device 61, a user uses the identical interconnection as in the prior art illustrated in FIG. 2.

This apparatus is ideal for storing a peripheral device specific software and reference data due to its physical attachment and sharing of the interface without any additional connectivity from users' point of view. For example, the interconnection shown in FIG. 4 via devices 63, 64 and 66 is essentially identical to the interconnection via devices 14, 15 and 18 in the prior art shown in FIG. 2.

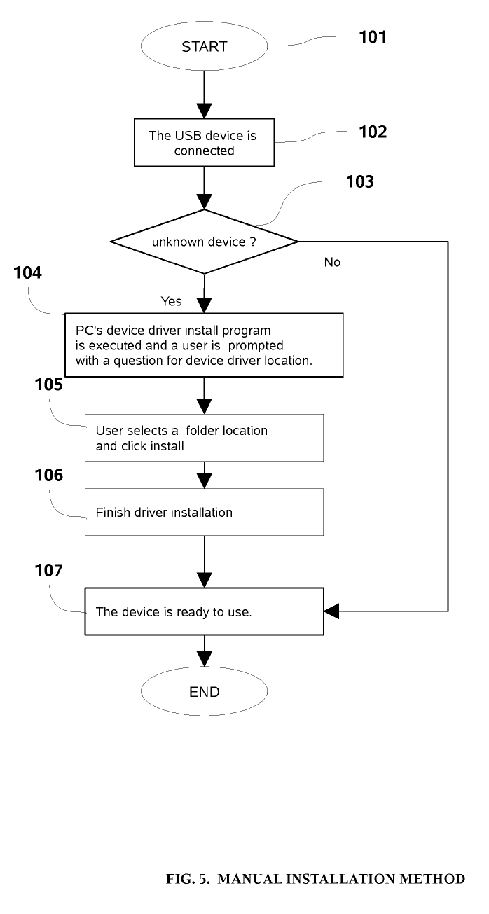

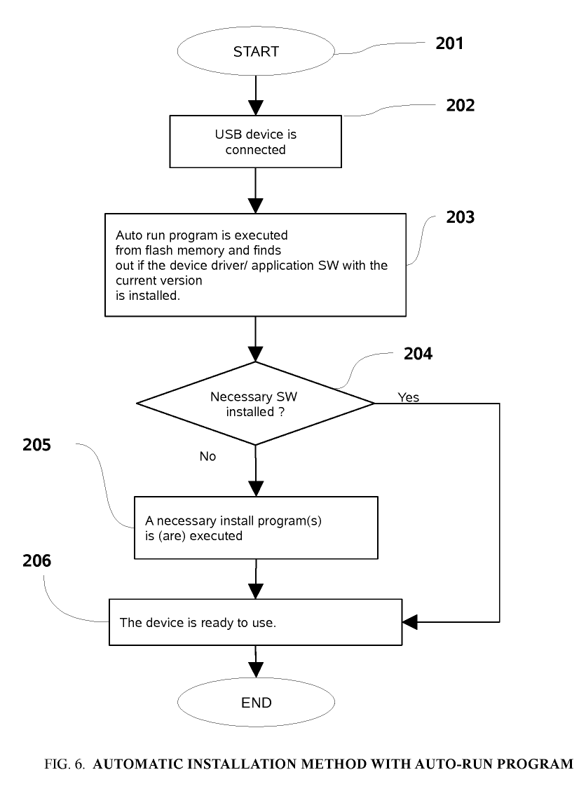

Software installation is streamlined by the fact that the required software is always available in a physically known location, i.e., non-volatile (flash) memory in the same port as the peripheral device itself. Whenever it is necessary to install a driver software, one needs to point to the pre-defined location (for example, a flash memory folder representing the memory space in 52 in FIG. 3 or 67 in FIG. 4) within the pass-through adaptor. A basic manual software installation process is shown in FIG. 5. When a USB peripheral device is inserted, the operating system detects the device (101 and 102), then the operating system checks if the device is known (or driver is installed) at 103 in FIG. 5. If not, the operating system asks for driver software location at 104. According to current invention, user does not need to insert CD/DVD nor search for software in the file system as in the prior art, but rather point to the known default flash memory storage location as a source of necessary software at 105. User waits for the completion of the install process at 105 and the device is ready for use at 107.

As is well known to a skilled person in the art, an auto-run program in a USB flash memory system can be executed automatically when the flash memory system is detected. In the current invention, the auto-run program is a device driver and/or application software inspection program that checks for the existence of the proper software installed in the host computer. This program is executed at 203 and determines if a software installation is necessary at 204. If it is determined that software installation or update is necessary at 205, the necessary software that matches to the operating system is installed or upgraded from the flash memory. All this process is done automatically without a user intervention. As a result, a peripheral device with current adaptor is self-contained in terms of software and hardware requirements. It is virtually ready to be used anytime for any computer as long as the peripheral device manufacturer supports the operating system in a computer. When a driver or application software upgrade is necessary, a user only need to upgrade the software in the adaptor flash memory regardless of how many computers are used with the device. The actual software updates for a host computer will be done automatically when a peripheral device with the adaptor is connected to a host computer subsequently. As is well know to a skilled person in the art, a software update can be automated with internet connectivity. As a result, the chain of software updates from flash memory updates to host computers updates can be fully automated without users' intervention.

What is claimed is:

1. A device comprising: a computer port interface, non-volatile memory system and a hub with a minimum of one-to-two port expansion in one integrated form factor.

2. The device of claim 1, wherein one of the expanded port is connected to said non-volatile memory and one of the remaining port(s) is connected a target peripheral device.

3. The device of claim 2, wherein both said non-volatile memory and said target peripheral device can be accessed by a host computer.

4. The device of claim 1, wherein said device is constructed as a pass-through adaptor to the peripheral device.

5. The device of claim 4, wherein said device is integrated into a peripheral device.

6. The device of claim 4, wherein said pass-through adaptor is integrated into a cable.

7. A method of storage for peripheral device specific software and data through a single interface shared with a target peripheral device.

8. The method of claim 7, wherein the software and data are stored in non-volatile memory in an adaptor device physically attached to said target peripheral device.

9. The method of claim 7, wherein the software storage device is integrated into said target peripheral device sharing the interface without additional interconnection.

10. The method of claim 7, wherein said software includes a device driver and/or application software for said target peripheral device.

11. The method of claim 7, wherein said data includes a reference information such as data book or user manuals.

12. A method of software installation where the installation software is accessed through a shared interface with a target peripheral device.

13. The method of claim 12, wherein a user can manually choose and select desired software for installation.

14. The method of claim 12, wherein an auto run program detects what software is necessary and automatically starts installing necessary software without user's manual intervention.

15. The method of claim 12, wherein software is automatically updated and saved in the said non-volatile memory when an internet connectivity in a host computer is available.
